(19) United States
(12) Patent Application Publication
(10) Pub. No.: US 2010/0191731 A1
(43) Pub. Date: Jul. 29, 2010

(54) METHODS AND SYSTEMS FOR AUTOMATIC CLUSTERING OF DEFECT REPORTS

(76) Inventors: Vasile Rus, Memphis, TN (US); Sajjan Shiva, Collierville, TN (US)

Correspondence Address: EDWARDS ANGELL PALMER & DODGE LLP, P.O. BOX 55874, BOSTON, MA, 02205, US

(21) Appl. No.: 12/359,032

(22) Filed: Jan. 23, 2009

(51) Int. Cl. G06F 17/30

(52) U.S. Cl. 707/737; 707/E17.089

(57) ABSTRACT

One embodiment of the invention provides a method of grouping defects. The method includes the steps of obtaining a plurality of defect reports, preprocessing the defect reports, and applying a clustering algorithm, thereby grouping the defect reports. Another embodiment of the invention provides a computer-readable medium whose contents cause a computer to perform a method comprising: obtaining a plurality of defect reports; preprocessing the defect reports; and applying a clustering algorithm, thereby grouping the defect reports. Another aspect of the invention provides a system for grouping defect reports. The system includes: a preprocessing module, a representation module in communication with the preprocessing module, and a clustering module in communication with representation module.

### TECHNICAL FIELD

The invention relates to method and systems for grouping defect reports.

### BACKGROUND

Despite decades of research in the field of software engineering, software programs do not always function properly. In order to detect and remedy problems in software programs, various systems are implemented to collect information on problems so that the problems can be identified and remedied.

Defect reports are detailed descriptions in natural language of defects, i.e. problems in a software product. The quality and proper handling of defect reports throughout the testing process has a great impact on the quality of the released software product. Defect reports are currently analyzed manually by testers, developers, and other stakeholders. Manual analysis is tedious, error-prone, and time consuming, leading to a less-efficient testing process.

Accordingly, there is a need for an automated process for extracting meaningful data from defect reports.

### SUMMARY OF THE INVENTION

One aspect of the invention provides a method of grouping defect reports. The method includes obtaining a plurality of defect reports, preprocessing the defect reports, and applying a clustering algorithm, thereby grouping the defect reports.

This aspect can have several embodiments. The defect reports can be software defect reports. The step of preprocessing the defect reports can includes tokenizing the plurality of defect reports. The step of preprocessing the defect reports can include removing one or more stop words from the plurality of defect reports. The step of preprocessing the defect reports can include lemmatizing the plurality of defect reports.

The clustering algorithm can be K-means, Expectation-Maximization, FarthestFirst, a hierarchical clustering algorithm, a density-based clustering algorithm, a grid-based clustering algorithm, a subspace clustering algorithm, a graph-partitioning algorithms, fuzzy c-means, DENCLUE, hierarchical agglomerative, DBSCAN, OPTICS, minimum spanning tree clustering, BIRCH, CURE, and/or Quality Threshold.

The defect reports can be represented in a vector space model. A plurality of works in the defect reports can be weighted. The weighting can be calculated according to TF-IDF. The method can include computing the prevalence of a plurality of defects.

The plurality of defect reports can be in a language selected from the group consisting of: Mandarin, Hindustani, Spanish, English, Arabic, Portuguese, Bengali, Russian, Japanese, German, Punjabi, Wu, Javanese, Telugu, Marathi, Vietnamese, Korean, Tamil, French, Italian, Sindhi, Turkish, Min, Gujarati, Maithili, Polish, Ukranian, Persian, Malayalam, Kannada, Tamazight, Oriya, Azerbaijani, Hakka, Bhojpuri, Burmese, Gan, Thai, Sundanese, Romanian, Hausa, Pashto, Serbo-Croatian, Uzbek, Dutch, Yoruba, Amharic, Oromo, Indonesian, Filipino, Kurdish, Somali, Lao, Cebuano, Greek, Malay, Igbo, Malagasy, Nepali, Assamese, Shona, Khmer, Zhuang, Madurese, Hungarian, Sinhalese, Fula, Czech, Zulu, Quechua, Kazakh, Tibetan, Tajik, Chichewa, Haitian Creole, Belarusian, Lombard, Hebrew, Swedish, Kongo, Akan, Albanian, Hmong, Yi, Tshiluba, ilokano, Uyghur, Neapolitan, Bulgarian, Kinyarwanda, Xhosa, Balochi, Hiligaynon, Tigrinya, Catalan, Armenian, Minangkabau, Turkmen, Makhuwa, Santali, Batak, Afrikaans, Mongolian, Bhili, Danish, Finnish, Tatar, Gikuyu, Slovak, More, Swahili, Southern Quechua, Guarani, Kirundi, Sesotho, Romani, Norwegian, Tibetan, Tswana, Kanuri, Kashmiri, Bikol, Georgian, Qusqu-Qullaw, Umbundu, Konkani, Balinese, Northern Sotho, Luyia, Wolof, Bemba, Buginese, Luo, Maninka, Mazanderani, Gilaki, Shan, Tsonga, Galician, Sukuma, Yiddish, Jamaican Creole, Piemonteis, Kyrgyz, Waray-Waray, Ewe, South Bolivian Quechua, Lithuanian, Luganda, and Lusoga.

The plurality of defect reports can be represented solely by content words. The plurality of defect reports can be represented solely by nouns. The method can be performed on a general purpose computer containing software implementing the method.

Another aspect of the invention provides a computer-readable medium whose contents cause a computer to perform a method comprising obtaining a plurality of defect reports, preprocessing the defect reports, and applying a clustering algorithm, thereby grouping the defect reports.

Another aspect of the invention provides a system including: a computer-readable medium whose contents cause a computer to perform a method comprising obtaining a plurality of defect reports, preprocessing the defect reports, and applying a clustering algorithm, thereby grouping the defect reports; and a computer in data communication with the computer-readable medium.

Another aspect of the invention provides a system for grouping defect reports. The system includes: a preprocessing module, a representation module in communication with the preprocessing module, and a clustering module in communication with representation module.

This aspect can have several embodiments. The system can further include: a tokenization module, a stop word removal module, and a lemmatization module. The system can also include a defect database.

### FIGURES

For a fuller understanding of the nature and desired objects of the present invention, reference is made to the following detailed description taken in conjunction with the accompanying figure wherein:

FIG. 1 depicts a method for grouping defect reports according to one embodiment of the invention.

FIG. 2 depicts a system for grouping defect reports according to one embodiment of the invention.

### DESCRIPTION OF THE INVENTION

This invention addresses the challenging task of clustering defect reports. Defect reports are detailed descriptions in natural language of defects, i.e. problems in a software product.

The invention provides automatic methods to analyze defect reports. In particular, the invention provides automatic methods for clustering defect reports in order to discover patterns among reported defects. Clustering can reveal sets of related problems and this information can be further used to better plan the testing effort. For instance, a large cluster of related reports could indicate which feature(s) of the software product needs to be further tested. While a cluster of defect reports that look similar content-wise may not always describe the same underlying bug, i.e. root cause, such a cluster can highlight visible features of a product that need more attention from the testing team.

This invention addresses the more challenging task of clustering defect reports based on their describing the same underlying bug. This is possible by evaluating the clustering using reports that were judged by developers as being duplicates, i.e. describing the same bug.

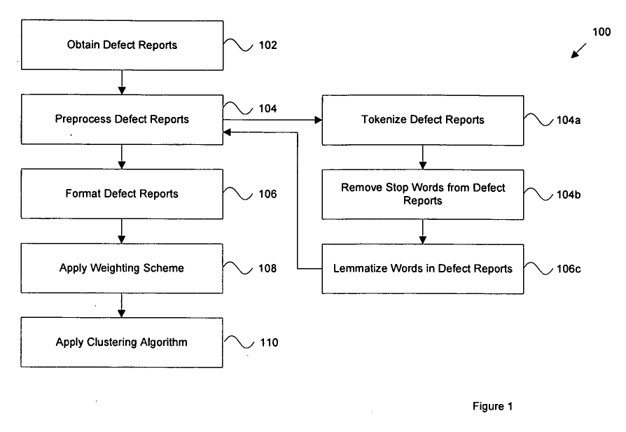

Referring to FIG. 1, one embodiment of the invention includes a method for grouping defect reports with respect to an underlying defect. The method includes the steps of obtaining defect reports (102), preprocessing defect reports (104), formatting defect reports (106), applying a weighting scheme (108), and applying a clustering algorithm (110). The step of preprocessing defect reports can include the steps of tokenizing defect reports (104a), removing stop words from defect reports (104b), and lemmatizing or stemming words in defect reports (106a). The steps of this method are described in greater detail below.

### Defect Reports

Defect reports are filed by testers (or users) who discover defects through testing (or use). The reports are stored in a defect database. One or more developers review open (i.e. not yet fixed) defects from the database, analyze the corresponding reports, and fix the defects. Defect reports can include many details about the corresponding defects including an ID that uniquely identifies the defect, the status of the defect (e.g. new, verified, resolved), a summary field, and a description field. The description field is the richest source of information about the defect. The field describes details about the defect in plain natural language, including symptoms and steps to reproduce the defect. The summary field can be a one-sentence description of the problem.

During testing, defects within software are discovered through testing (and fixed) and new functionality is added, which must be tested. The testers report defects using a defect management tool, also called defect tracking tool, the back-end of which is typically a relational database. The general process of handling defect reports includes the following steps: the defect is found and filed in the defect tracking tool, the report is evaluated by an analyst, the defect is assigned to a developer, the developer finds the defect and fixes it, and the defect report is closed. The tester, analyst, and developer could be the same or different persons depending on the size of the project. In some situations such as open source projects, users voluntarily report defects.

The inventions herein are explained and demonstrated in the context of the MOZILLA® open source project, and specifically with respect to the BUGZILLA™ software program—a bug tracking tool that allows testers to report bugs and assign the bugs to developers. Developers can use the BUGZILLA™ software to keep a to-do list as well as to prioritize, schedule, and track dependencies. Not all entries in the BUGZILLA™ software are bugs. Some entries are “Requests For Enhancement” or RFEs. An RFE is a report whose severity field is set to enhancement.

Ideally, before reporting a defect, the tester reproduces the bug using a recent build of the software to see whether it has already been fixed, and searches the BUGZILLA™ software to check whether the bug has already been reported. If the bug can be reproduced and no one has previously reported it, the tester can file a new defect report including: the component in which the defect exists, the operating system on which the defect was found, a quick summary of about 60 or less characters, a detailed description of the defect, and attachments, for instance screenshots.

A good summary should quickly and uniquely identify the defect. It should explain the problem, not the suggested solution. An example of a good summary is “Canceling a File Copy dialog crashes File Manager”, while bad examples include “Software crashes” and “Browser should work with my web site”.

The description field is a detailed account of the problem. The description field of a defect report should contain the following major sections, although the breakdown of the field into these sections is not enforced in the BUGZILLA™ software:
overview (more detailed restatement of summary);
steps to reproduce (minimized, easy-to-follow steps that will trigger the bug, including any special setup steps);
actual results (what the application did after performing the above steps);
expected results (what the application should have done, were the bug not present);
build date & platform (date and platform of the build in which the tester first encountered the bug); and
additional builds and platforms (whether or not the bug takes place on other platforms or browsers, if applicable), and additional information (any other useful information).

Any deviation from the above guidelines leads to vague reports which in turn lead to a less efficient process of handling the defects. On the other hand, recording every detail about a defect may be unnecessary. The reality is that defect reports rarely include all the above suggested details.

### Defect Report Preprocessing

In some embodiments of the invention, each defect report is preprocessed before it is mapped onto a meaningful computation representation, such as a vectorial representation, used in later steps of the methods. Preprocessing maps a report onto a list of tokens that have linguistic meaning, i.e. words. Preprocessing can include one or more of the following steps: tokenization, stop word removal, and lemmatization.

Tokenization separates punctuation from words. Stop words (also called “stopwords” or “noise words”) are common words that appear in too many documents and therefore do not have discriminative power. That is, stopwords cannot be used to capture the essence of a document such that one can differentiate one document from another. Standard lists of stop words are provided in software programs such as the SMART Information Retrieval System, available from Cornell University of Ithaca, N.Y. The SMART stop word list is available at ftp://ftp.cs.cornell.edu/pub/smart/english.stop. A collection of stopwords for a particular set of documents can be created by selecting the words that occur in more than 80% of the documents. See R. Baeza-Yates & B. Ribeiro-Neto, Modern Information Retrieval §7.2 (1999).

Lemmatization maps each morphological variation of a word to its base form. For example, the words, “go”, “going”, “went”, and “gone” are lemmatized to “go”, their root or base form. Lemmatizers include the WORDNET® system, available from Princeton University of Princeton, New Jersey. Other lemmatizers can be used, including the MORPHA™ software described in G. Minnen et al., Applied morphological processing of English, 7(3) Natural Language Engineering 207-23 (2001) and available at http://www.informatics.susx.ac.uk/ research/groups/nlp/carroll/morph.html.

### Defect Report Representation

The invention provided herein is compatible with a variety of defect report representation formats. For example, the invention can cluster based on the description field or the summary field. Furthermore, the summary or description can be represented all words in the summary or description, only content words (i.e. nouns, verbs, adjectives, and adverbs), or only nouns.

In one embodiment, the defect report representation format employs the vector space model. The vector space model is described in R. Baeza-Yates & B. Ribeiro-Neto, Modern Information Retrieval (1999); P. Runeson et al., Detection of duplicate defect reports using natural language processing, in Proc. 28^{th} Int'l Conf. Software Eng. (2007); and J. N. och Dag et al., Speeding up requirements management in a product software company: Linking customer wishes to product requirements through linguistic engineering, in Int'l Conf. of Requirements Eng. (2007).

Defect reports are mapped onto a vectorial representation where each report is a |V| dimensional vector, where V is the vocabulary of a large collection of defect reports and |V| is the size of the vocabulary. The vocabulary is obtained by extracting unique words after preprocessing the collection. Each dimension in this space of |V| dimensions corresponds to a unique word in the collection and the value along the dimension is a weight which indicates the importance of the word/dimension for a particular report dⱼ. Below is an example representation for report dⱼ:

dⱼ=[w₁, w₂, w₃, . . . , w_{|V|}]

where wᵢ is the weight of word i in document dⱼ. Usually, if a word is not present in a document dⱼ, the corresponding value in the vector for the word is zero. Many weighting schemes can be used. The so-called TF-IDF scheme is discussed below.

Some embodiments of the invention employ the TF-IDF weighting scheme to assign weights to words in the defect model. The TF-IDF scheme is a composed measure that is the product of the frequency of a term in a document (TF) and its inverted document frequency (IDF). TF-IDF provides a metric measuring the importance of words. A word will receive a high value if it frequently appears in the document (TF) and does not occur often in other documents (IDF).

The TF (“term frequency”) value for term ti within document dⱼ can be expressed mathematically as:

$${TF}_{i , j} = \frac{{n}_{i , j}}{{max}_{k} {n}_{k , j}}$$

wherein n_{i,j} is the number of occurrences of the considered term in document dⱼ, and the denominator is the frequency of the most frequent term in document dⱼ. The denominator is used to normalize the TF values. Other normalization factors can be used such as the most frequent word in any document in the collection or the number of occurrences of all terms in document dⱼ.

The IDF of a word is the percentage of distinct documents the word appears in amongst a collection of documents. The IDF measures the specificity of a word. The fewer documents a word appears in, the more specific the word is. The IDF can be expressed mathematically as:

$${IDF}_{i} = log \frac{\vert D \vert}{\vert \{ {d}_{j} \text{:} {t}_{i} ∈ {d}_{j} \} \vert}$$

wherein |D| is the total number of documents in the corpus and |{dⱼ:tᵢ ε dⱼ}| is the number of documents where the term tᵢ appears (that is, n_{i,j}≠0).

### Defect Report Clustering

The invention utilizes a clustering algorithm such as the K-means algorithm to cluster defect reports. However, any other clustering algorithm can be used. Clustering is the unsupervised classification of patterns (usually represented as a vector of measurements, or a point in a multidimensional space) into groups (clusters) based on similarity. In other words, it is the process of organizing objects into groups whose members are similar in some way. A cluster is therefore a collection of objects which are similar to each other in the same cluster and are dissimilar to the objects belonging to other clusters.

Typical clustering involves the following steps, as discussed in A. K. Jain et al., Data clustering: a review, 31(3) ACM Computer Surveys 264-323 (1999):
data representation (optionally including feature extraction and/or selection),
definition of a similarity measure appropriate to the data domain,
clustering or grouping, and
assessment of output.

There are several major categories of clustering algorithms. Hierarchical clustering algorithms produce a nested series of partitions based on a criterion for merging or splitting clusters based on similarity. Density-based clustering algorithms discover arbitrary-shaped clusters by defining a cluster as a region in which the density of data objects exceeds a threshold. Grid-based clustering algorithm use a uniform grid mesh to partition the entire problem domain into cells. Data objects located within a cell are represented by the cell using a set of statistical attributes from the objects. Clustering is then performed on the grid cells instead of the data itself. Subspace clustering is an extension of traditional clustering that seeks to find clusters in different subspaces within a dataset. The DENCLUE algorithm employs a cluster model based on kernel density estimation. Partition-based clustering algorithms identify the partition that optimizes (usually locally) a clustering criterion.

An exemplary hierarchical clustering algorithm is the hierarchical agglomerative (HAC) algorithm. In HAC, each data point is initially regarded as an individual cluster and then the task is to iteratively combine two smaller clusters into a larger one based on the distance between their data points.

Exemplary density-based include the DBSCAN and OPTICS algorithms. The DBSCAN algorithm is described in Domenic Arlia & Massimo Coppola, Experiments in Parallel Clustering with DBSCAN, 2150 Lecture Notes in Comp. Sci. 326-31 (2001). The OPTICS algorithm is described in Michael Ankerst et al., OPTICS: Ordering Points to Identify the Clustering Structure, SIGMOD '99: Proc. 1999 ACM SIGMOD Int'l Conf. Management of Data 49-60 (1999).

Grid-based clustering algorithms are described in Krzysztof J. Cios et al., Data Mining: A Knowledge Discovery Approach 272-74 (2007) and Nam Hun Park & Won Suk Lee, Statistical Grid-based Clustering over Data Streams, 33(1) SIGMOD Record 32-37 (March 2004).

Subspace clustering algorithms are described in Lance Parsons et al., Subspace Clustering for High Dimensional Data: A Review, 6(1) Sigkdd Explorations 90-105 (June 2004).

The DENCLUE algorithm is described in Alexander Hinneburg & Hans-Henning Gabriel, DENCLUE 2.0: Fast Clustering Based on Kernel Density Estimation, 4723 Lecture Notices in Comp. Sci. 70-80 (2007). The DENCLUE algorithm can be used in conjunction with self-organizing maps, which are described in Krzysztof J. Cios et al., Data Mining: A Knowledge Discovery Approach 272-74 (2007), and mixture models, which are described by Hinneburg and Gabriel.

Graph-partitioning algorithms are described in Francesc Comellas & Emili Sapena, A Multiagent Algorithm for Graph Partitioning, 3907 Lecture Notes in Comp. Sci. 279-85 (2006). Exemplary graph-partitioning algorithms include minimum spanning tree (MST) clustering, which is described in Ulrik Brandes et al., Engineering Graph Clustering: Models and Experimental Evaluation, 12 ACM J. Exp. Algorithms 1 (June 2008), and shared nearest neighbor (SNN) clustering, which is described in Pierre-Alain Moëllic et al, Image Clustering Based on a Shared Nearest Neighbors Approach for Tagged Collections, CIVR '08: Proceedings of the 2008 Int'l Conf. on Content-Based Image & Video Retrieval 269-78 (July 2008).

Exemplary scalable clustering algorithms include the BIRCH and CURE algorithms. The BIRCH algorithm is described in Tian Zhang et al., BIRCH: An Efficient Data Clustering Method for Very Large Databases, in SIGMOD '96: Proc. 1996 ACM SIGMOD Int'l Conf. on Management of Data 103-14 (June 1996). The CURE algorithm is described in Sudipto Guha et al., CURE: an efficient clustering algorithm for large databases, in SIGMOD '98: Proc. 1998 ACM SIGMOD Int'l Conf. on Management of Data 73-84 (June 1998).

An exemplary partition-based clustering algorithm is the K-means algorithm is described (along with Lloyd's Algorithm), for example, in Stuart P. Lloyd, Least Squares Quantization in PCM, IT-28(2) IEEE Trans. Infor. Theory 129-37 (March 1982). Other partition-based algorithms include the Expectation-Maximization (EM), FarthestFirst, fuzzy c-means, and Quality Threshold (QT) algorithms. The EM algorithm is described in Ian H. Witten & Eibe Frank, Data Mining: Practical Machine Learning Tools & Techniques with Java Implementations 276 (1st ed. 1999). Both the EM and the FarthestFirst algorithms are implemented in data mining software such as WEKA®, available from WaikatoLink Limited of Hamilton, New Zealand, and described in Ian H. Witten & Eibe Frank, Data Mining: Practical Machine Learning Tools & Techniques (2d ed. 2005). The fuzzy c-means algorithm is discussed in J. C. Dunn, A Fuzzy Relative of the ISODATA Process and Its Use in Detecting Compact Well-Separated Clusters, 3 J. Cybernetics 32-57 (1973) and J. C. Bezdek, Pattern Recognition with Fuzzy Objective Function Algorithms (1981). The QT algorithm is described in L. J. Heyer et al., Exploring Expression Data: Identification & Analysis of Coexpressed Genes, 9 Genome Research 1106-15 (1999).

In the K-means algorithm, the number of clusters (k) is specified a priori. In testing, this is useful when testers want to identify k (e.g. k=20) clusters in the set of open defects. The algorithm usually starts with k seed data points which are considered as individual clusters. In subsequent iterations, the remaining data points are added to some cluster based on the distance to the centroid of each cluster. The centroid is an abstract data point of an existing cluster that is found by averaging over all the other points in the cluster. The steps of (1) assigning data points to a cluster and (2) recalculating the centroids for each cluster are repeated until the algorithm converges.

A distance metric must be defined for clustering algorithms. In some implementations of the K-means algorithm such as the Simp l eKMe an s function in WEKA®, the Euclidean distance is calculated. As is known, the Euclidean distance between points P=(p₁, p₂, . . . , pₙ) and Q=(q₁, q₂, . . . , qₙ) in Euclidean n-space is defined as:

$$\sqrt{{( {p}_{1} - {q}_{1} )}^{2} + {( {p}_{2} - {q}_{2} )}^{2} + … + {( {p}_{n} - {q}_{n} )}^{2}} = \sqrt{{\sum }_{i = 1}^{n} {( {p}_{i} - {q}_{i} )}^{2}} .$$

Various other distance metrics can be used in the invention including Manhattan distance, maximum norm, Mahalanobis distance, and Hamming distance.

Some implementations of K-means only allow numerical values for attributes. In these implementations, categorical attributes are converted to numerical values. It may also be necessary to normalize the values of attributes that are measured on substantially different scales. The WEKA® software's S impleKMeans algorithm automatically handles a mixture of categorical and numerical attributes. Furthermore, the algorithm automatically normalizes numerical attributes when performing distance computations.

The advantage of using K-means is that it is very easy to implement and relatively efficient i.e. O(t×k×n) where n is the number of objects, k is the number of clusters and t is the number of iterations. In many cases, the k, t<<n and hence can be ignored.

### Implementation in Computer Readable Media or Systems

One skilled in the art will readily recognize that the method described herein can be implemented on computer readable media or a system. An exemplary system includes a general purpose computer containing software configured to execute the methods described herein.

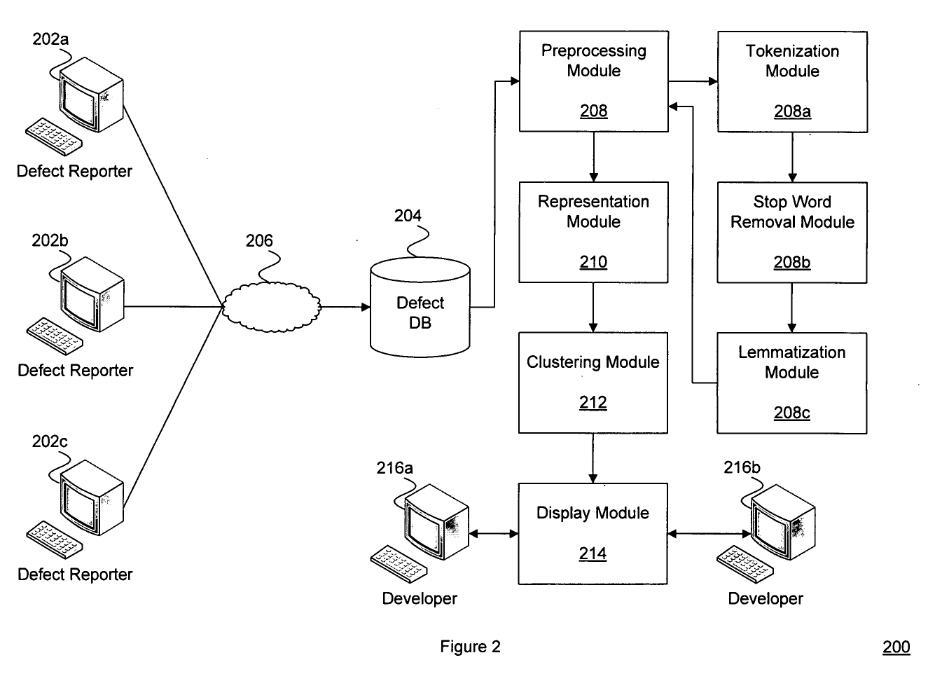

For the purposes of illustration, an exemplary system architecture 200 is depicted in FIG. 2. Defects are submitted by a plurality of defect reporters 202a, 202b, 202c. As discussed herein, defect reporters need not be any particular type of computer, but rather can include any type of electronic device include mobile devices (e.g. cellular telephones, personal digital assistants, Global Positioning Systems), household appliances, and the like. Defects can be submitted automatically (e.g. when a crash or an exception occurs), semi-automatically (e.g. when a crash or an exception occurs, but only after requesting the user's permission to submit the defect report), or manually (e.g. a user sending an email or completing a form to report the defect).

Defects can be transmitted to a defect database 204 via a network 206. Network 206 can include any network topology known to those of skill in the art, such as the Internet. Defect database can be operated through a database management system (DBMS). A DBMS is imposed upon the data to form a logical and structured organization of the data. A DBMS lies between the physical storage of data and the users and handles the interaction between the two. Examples of DBMSes include DB2® and Informix® both available from IBM Corp. of Armonk, N.Y.; Microsoft Jet® and Microsoft SQL Server® both available from the Microsoft Corp. of Redmond, Wash.; MySQL® available from the MySQL Ltd. Co. of Stockholm, Sweden; Oracle® Database, available from Oracle Int'l Corp of Redwood City, Calif.; and Sybase® available from Sybase, Inc. of Dublin, Calif.

Data is obtained from the defect database 204 by preprocessing module 208. Preprocessing module 208 maps a report onto a list of tokens that have linguistic meaning, i.e. words. Preprocessing modules can optionally be in communication or include one or more modules or submodules for tokenization (208a), stop word removal (208b), and/or lemmatization (208c).

Once the defect report is preprocessed, the defect reports are passed to representation module 210. Representation module 210 can convert the defect report into a representation format such as the vector space model. The representation module can also apply a weighting scheme such as the TF-IDF scheme.

Once the defect report is converted into a suitable representation format, the defect reports are passed to clustering module 212. Clustering module 212 applies one or more clustering algorithms as described herein.

Data regarding clusters is passed to display module 214, where the data can be accessed by one or more developers 216a, 216b. The data can be arranged in a textual and/or graphical format. For example, a list can be presented detailing the most prevalent clusters by number of defect reports. A developer 216a, 216b can then “drill down” to view the individual defect reports, e.g. by clicking on the cluster.

As will be appreciated by one of skill in the art, the modules described herein can be implemented as components, i.e. functional or logical components with well-defined interfaces used for communication across components. For example, a data clustering system can be assembled by selecting a preprocessing component from amongst several components (e.g. components that implement various approaches to tokenization, stop word removal, and/or lemmatization) and combining this component with a representation component and a clustering component.

Moreover, one of skill in the art will appreciate that a copy of the defect report need not be passed between modules. Rather, the defect report and representations thereof can be “passed by reference” by the use of “handles”.

### Clustering in Foreign Language Documents

The invention described herein can be used to perform clustering documents such as defect reports in foreign languages such as Mandarin, Hindustani, Spanish, English, Arabic, Portuguese, Bengali, Russian, Japanese, German, Punjabi, Wu, Javanese, Telugu, Marathi, Vietnamese, Korean, Tamil, French, Italian, Sindhi, Turkish, Min, Gujarati, Maithili, Polish, Ukranian, Persian, Malayalam, Kannada, Tamazight, Oriya, Azerbaijani, Hakka, Bhojpuri, Burmese, Gan, Thai, Sundanese, Romanian, Hausa, Pashto, Serbo-Croatian, Uzbek, Dutch, Yoruba, Amharic, Oromo, Indonesian, Filipino, Kurdish, Somali, Lao, Cebuano, Greek, Malay, Igbo, Malagasy, Nepali, Assamese, Shona, Khmer, Zhuang, Madurese, Hungarian, Sinhalese, Fula, Czech, Zulu, Quechua, Kazakh, Tibetan, Tajik, Chichewa, Haitian Creole, Belarusian, Lombard, Hebrew, Swedish, Kongo, Akan, Albanian, Hmong, Yi, Tshiluba, Ilokano, Uyghur, Neapolitan, Bulgarian, Kinyarwanda, Xhosa, Balochi, Hiligaynon, Tigrinya, Catalan, Armenian, Minangkabau, Turkmen, Makhuwa, Santali, Batak, Afrikaans, Mongolian, Bhili, Danish, Finnish, Tatar, Gikuyu, Slovak, More, Swahili, Southern Quechua, Guarani, Kirundi, Sesotho, Romani, Norwegian, Tibetan, Tswana, Kanuri, Kashmiri, Bikol, Georgian, Qusqu-Qullaw, Umbundu, Konkani, Balinese, Northern Sotho, Luyia, Wolof, Bemba, Buginese, Luo, Maninka, Mazanderani, Gilaki, Shan, Tsonga, Galician, Sukuma, Yiddish, Jamaican Creole, Piemonteis, Kyrgyz, Waray-Waray, Ewe, South Bolivian Quechua, Lithuanian, Luganda, Lusoga, Acehnese, Kimbundu, Hindko, Ibibio-Efik, and the like.

### Working Example

Clustering software defect reports can take different forms. For instance, the clustering can be based on either the severity of the bug, or based on the fact that the defect reports describe the same defect, i.e. they are duplicates, or based on other criteria such as component/feature-specific clustering, e.g. clustering printer-related defect reports.

In this working example, defect reports were clustered based on the underlying bug. A defect report and its duplicates are considered a cluster. This modeling is adequate as the original defect report should be similar, content-wise, to its duplicates. The data used in the experiments comes from the MOZILLA® BUGZILLA™ software where duplicate information is available. The duplicates are marked as such by members of the Mozilla development team and thus deemed highly reliable. The experimental data was automatically collected from the MOZILLA® BUGZILLA™ database as described next.

To create the data set, 20 bugs were collected from the “Hot Bugs List” in the MOZILLA® BUGZILLA™ database. The Hot Bugs List contains the most filed recently bugs. The list can be sorted based on the number of duplicates (indicated by the “Dupes” field for each entry in the Hot Bugs List). A secondary criterion for selecting the reports was the severity of the reports in order to achieve diversity among the clusters in terms of severity. The top 20 defect reports from the Hot Bugs List in terms of largest number of duplicates and diversity of severity were selected for the experimental data set. Fifty (50) duplicates for each of the 20 defect reports were selected. Hence, the total number of bugs considered was 1,020. Only the top 20 bugs from the Hot Bugs List were chosen because only these bugs had more than 50 duplicate each. Having fewer than 50 duplicates for each original bug would have led to too small clusters. The list of 1,020 bugs served as input to the data collection module of the invention that automatically collects over the Internet (from the MOZILLA® BUGZILLA™ database) the Description and Summary of these 1020 bugs and stores them locally in text files.

The final data set contained 1,003 data points because 17 reports which lacked proper description fields were eliminated. For these eliminated reports, the description field was empty or was simply redirecting the user to another bug, e.g. the field contained textual pointers such as, “see bug #123”.

The data set was further processed and analyzed with two data mining tools: RAPIDMINER™ and WEKA®. The RAPIDMINER™ software is described in I. Mierswa et al., Yale: Rapid prototyping for complex data mining tasks, in Proc. 12th ACM SIGKDD Int'l Conf. on Knowledge Discovery and Data Mining (KDD-06) (2006) and is available from Rapid-I GmbH of Dortmund, Germany at www.rapid-i.com. RAPIDMINER™ software was used to generate the vectorial representations for defect reports. WEKA® software was used to apply the K-means clustering algorithm to the data set. The two processing steps are explained in more details below.

A TF-IDF generation module computes the TF-IDF weights for each term in the vocabulary. Suitable TF-IDF generation modules include the com. rapidminer. operator. preprocessing. filter. TFIDFFilter provided in the RAPIDMINER™ software. For Description documents, i.e. reports represented using their Description field, the vocabulary size was 4,569. The vocabulary size dictates the number of dimensions of the document vectors in the vectorial representation. For Summary documents, the vocabulary size was 991. Summary-based representation resulted in increased efficiency due to the lower dimensionality as compared to description-based representation. In the next step, the defect reports in vectorial representation are mapped to a format that WEKA® requires in order to perform cluster, such as the ARFF (Attribute Relation File Format) file format. This file can be generated using the RAPIDMINER™ ArffExampleSetWriter operator.

The SimpleKMeans algorithm in WEKA® was used to obtain clusters and automatically evaluate the performance of the clustering. The WEKA® software's SimpleKMeans algorithm uses Euclidean distance measure to compute distances between instances and clusters. To perform clustering, the following parameters are set including: number of clusters, which informs the clustering algorithm how many clusters to generate, and seed. The seed value is used in generating a random number which is, in turn, used for making the initial assignment of instances to clusters. In general, K-means is quite sensitive to how clusters are initially assigned and thus it is often necessary to try different values and evaluate the results.

The clustering accuracy is the number of documents correctly clustered divided by the total number of documents. The WEKA® software includes an evaluation module that automatically compares the output of the clustering algorithm to the correct clustering, which in this case are the expert human judgments regarding whether one description should be in the same cluster as another. In this application, the determination that two or more descriptions should be clustered represents a determination that the reports are duplicates.

The performance of the K-means clustering algorithm depends on the number of seeds initially used to start the clustering. Experiments were conducted with various values for the seed parameter to determine the best number of seeds to use. The seed value was varied from 0 to 1,003 in increments of 1. For Description-based representation of reports, the maximum performance was found to be for the seed value 33, which is 47.7567%, and the minimum performance was found for the seed value 175, which is 7.2782%. The average performance obtained was about 29.3581%. For Summary-based representations, the maximum performance was found for seed value 825, which is 59.8205%, and the minimum performance was for seed value 275, which is 34.2971%. The average performance obtained was about 44.2240%. Thus, the invention is able to identify clusters of reports describing the same underlying problem with an accuracy of 44.2240%. A baseline approach would be to always guess one of the twenty clusters for an average accuracy of 5%. A statistical t-test (a=0.05) was used to compare the baseline to the invention and found the invention to be significantly (p≦0.0001) better than this baseline. The null hypothesis was that the average accuracy computed over 1,004 seed points is equal to the average accuracy of the baseline approach.

### Equivalents

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, computers, clients, servers and the like) shown as distinct for purposes of illustration may be incorporated within other functional elements, separated in different hardware or distributed in a particular implementation.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

### Incorporation by Reference

The entire contents of all patents, published patent applications, and other references cited herein are hereby expressly incorporated herein in their entireties by reference.

1. A method of grouping defect reports, the method comprising:
obtaining a plurality of defect reports;
preprocessing the defect reports; and
applying a clustering algorithm, thereby grouping the defect reports.

2. The method of claim 1, wherein defect reports are software defect reports.

3. The method of claim 1, wherein the step of preprocessing the defect reports includes:
tokenizing the plurality of defect reports.

4. The method of claim 1, wherein the step of preprocessing the defect reports includes:
removing one or more stop words from the plurality of defect reports.

5. The method of claim 1, wherein the step of preprocessing the defect reports includes:
lemmatizing the plurality of defect reports.

6. The method of claim 1, wherein the clustering algorithm is K-means.

7. The method of claim 1, wherein the clustering algorithm is Expectation-Maximization.

8. The method of claim 1, wherein the clustering algorithm is FarthestFirst.

9. The method of claim 1, wherein the clustering algorithm is one or more selected from the group consisting of: a hierarchical clustering algorithm, a density-based clustering algorithm, a grid-based clustering algorithm, a subspace clustering algorithm, a graph-partitioning algorithms, fuzzy c-means, DENCLUE, hierarchical agglomerative, DBSCAN, OPTICS, minimum spanning tree clustering, BIRCH, CURE, and Quality Threshold.

10. The method of claim 1, wherein the defect reports are represented in a vector space model.

11. The method of claim 1, wherein a plurality of words in the defect reports are weighted.

12. The method of claim 11, wherein the weighting is calculated according to TF-IDF.

13. The method of claim 1, further comprising:
computing the prevalence of a plurality of defects.

14. The method of claim 1, wherein the plurality of defect reports are in a language selected from the group consisting of: Mandarin, Hindustani, Spanish, English, Arabic, Portuguese, Bengali, Russian, Japanese, German, Punjabi, Wu, Javanese, Telugu, Marathi, Vietnamese, Korean, Tamil, French, Italian, Sindhi, Turkish, Min, Gujarati, Maithili, Polish, Ukranian, Persian, Malayalam, Kannada, Tamazight, Oriya, Azerbaijani, Hakka, Bhojpuri, Burmese, Gan, Thai, Sundanese, Romanian, Hausa, Pashto, Serbo-Croatian, Uzbek, Dutch, Yoruba, Amharic, Oromo, Indonesian, Filipino, Kurdish, Somali, Lao, Cebuano, Greek, Malay, Igbo, Malagasy, Nepali, Assamese, Shona, Khmer, Zhuang, Madurese, Hungarian, Sinhalese, Fula, Czech, Zulu, Quechua, Kazakh, Tibetan, Tajik, Chichewa, Haitian Creole, Belarusian, Lombard, Hebrew, Swedish, Kongo, Akan, Albanian, Hmong, Yi, Tshiluba, Ilokano, Uyghur, Neapolitan, Bulgarian, Kinyarwanda, Xhosa, Balochi, Hiligaynon, Tigrinya, Catalan, Armenian, Minangkabau, Turkmen, Makhuwa, Santali, Batak, Afrikaans, Mongolian, Bhili, Danish, Finnish, Tatar, Gikuyu, Slovak, More, Swahili, Southern Quechua, Guarani, Kirundi, Sesotho, Romani, Norwegian, Tibetan, Tswana, Kanuri, Kashmiri, Bikol, Georgian, Qusqu-Qullaw, Umbundu, Konkani, Balinese, Northern Sotho, Luyia, Wolof, Bemba, Buginese, Luo, Maninka, Mazanderani, Gilaki, Shan, Tsonga, Galician, Sukuma, Yiddish, Jamaican Creole, Piemonteis, Kyrgyz, Waray-Waray, Ewe, South Bolivian Quechua, Lithuanian, Luganda, and Lusoga.

15. The method of claim 1, wherein the plurality of defect reports are represented solely by content words.

16. The method of claim 1, wherein the plurality of defect reports are represented solely by nouns.

17. The method of claim 1, wherein the method is performed on a general purpose computer containing software implementing the method.

18. A computer-readable medium whose contents cause a computer to perform a method comprising:
obtaining a plurality of defect reports;
preprocessing the defect reports; and
applying a clustering algorithm, thereby grouping the defect reports.

19. A system comprising:
a computer-readable medium as recited in claim 18; and
a computer in data communication with the computer-readable medium.

20. A system for grouping defect reports, the system comprising:
a preprocessing module;
a representation module in communication with the preprocessing module; and
a clustering module in communication with representation module.

21. The system of claim 20, further comprising:
a tokenization module;
a stop word removal module; and
a lemmatization module.

22. The system of claim 20, further comprising:
a defect database.
